(19) United States
(12) Patent Application Publication
(10) Pub. No.: US 2014/0282273 A1
(43) Pub. Date: Sep. 18, 2014

(54) SYSTEM AND METHOD FOR ASSIGNING VOICE AND GESTURE COMMAND AREAS

(71) Applicant: GLEN J. ANDERSON, Beaverton, OR (US)

(72) Inventor: GLEN J. ANDERSON, Beaverton, OR (US)

(21) Appl. No.: 13/840,525

(22) Filed: Mar. 15, 2013

(51) Int. Cl. G06F 3/01; G10L 15/22

(52) U.S. Cl. CPC G06F 3/017; G10L 15/22
USPC 715/863

(57) ABSTRACT

A system and method for assigning user input command areas for receiving user voice and air-gesture commands and allowing user interaction and control of multiple applications of a computing device. The system includes a voice and air-gesture capturing system configured to allow a user to assign three-dimensional user input command areas within the computing environment for each of the multiple applications. The voice and air-gesture capturing system is configured to receive data captured by one or more sensors in the computing environment and identify user input based on the data, including user speech and/or air-gesture commands within one or more user input command areas. The voice and air-gesture capturing system is further configured to identify an application corresponding to the user input based on the identified user input command area and allow user interaction with the identified application based on the user input.

### FIELD

The present disclosure relates to the user interfaces, and, more particularly, to a system and method for assigning voice and air-gesture command areas for interacting with and controlling multiple applications in a computing environment.

### BACKGROUND

Current computing systems provide a means of presenting a substantial amount of information to a user within a display. Generally, graphical user interfaces (GUIs) of computing systems present information to users inside content frames or “windows”. Generally, each window may display information and/or contain an interface for interacting with and controlling corresponding applications executed on the computing system. For example, one window may correspond to a word processing application and display a letter in progress, while another window may correspond to a web browser and display web page, while another window may correspond to a media player application and display a video.

Windows may be presented on a user's computer display in an area metaphorically referred to as the “desktop”. Current computing systems allow a user to maintain a plurality of open windows on the display, such that information associated with each window is continuously and readily available to the user. When multiple windows are displayed simultaneously, they may be independently displayed at the same time or may be partially or completely overlapping one another. The presentation of multiple windows on the display may result in a display cluttered with windows and may require the user to continuously manipulate each window to control the content associated with each window.

The management of and user interaction with multiple windows within a display may further be complicated in computing systems incorporating user-performed air-gesture input technology. Some current computing systems accept user input through user-performed air-gestures for interacting with and controlling applications on the computing system. Generally, these user-performed air-gestures are referred to as air-gestures (as opposed to touch screen gestures).

In some cases, extraneous air-gestures may cause unwanted interaction and input with one of a plurality running applications. This may be particularly true when a user attempts air-gestures in a multi-windowed display, wherein the user intends to interact with only one of the plurality of open windows. For example, a user may wish to control playback of a song on a media player window currently open on a display having additional open windows. The user may perform an air-gesture associated with the “play” command for the media player, such as a wave of the user's hand in a predefined motion. However, the same air-gesture may represent a different command for another application. For example, the air-gesture representing the “play” command on the media player may also represent an “exit” command for the web browser. As such, due to the multi-windowed display, a user's air-gesture may be ambiguous with regard to the particular application the user intends to control. The computing system may not be able to recognize that the user's air-gesture was intended to control the media player, and instead may cause the user's air-gesture to control a different and unintended application. This may particularly frustrating for the user and require a greater degree of user interaction with the computing system in order to control desired applications and programs.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one embodiment of a system for assigning voice and air-gesture command areas consistent with the present disclosure;

FIG. 2 is a block diagram illustrating another embodiment of a system for assigning voice and air-gesture command areas consistent with the present disclosure;

FIG. 3 is a block diagram illustrating the system of FIG. 1 in greater detail;

FIG. 4 illustrates an electronic display including an exemplary graphical user interface (GUI) having multiple windows displayed thereon and assigned voice and air-gesture command areas for interacting with the multiple windows consistent with the present disclosure;

FIG. 5 illustrates a perspective view of a computing environment including the electronic display and GUI and assigned voice and air-gesture command areas of FIG. 4 and a user for interacting with the GUI via the command areas consistent with various embodiments of the present disclosure; and

FIG. 6 is a flow diagram illustrating one embodiment for assigning voice and air-gesture command areas consistent with present disclosure.

### DETAILED DESCRIPTION

By way of overview, the present disclosure is generally directed to a system and method for assigning user input command areas for receiving user voice and air-gesture commands and allowing user interaction and control of a plurality of applications based on assigned user input command areas. The system includes a voice and air-gesture capturing system configured to monitor user interaction with one or more applications via a GUI within a computing environment. The GUI may include, for example, multiple open windows presented on an electronic display, wherein each window corresponds to an open and running application. The voice and air-gesture capturing system is configured to allow a user to assign user input command areas for one or more applications corresponding to, for example, each of the multiple windows, wherein each user input command area defines a three-dimensional space within the computing environment and in relation to at least the electronic display.

The voice and air-gesture capturing system is configured to receive data captured by one or more sensors in the computing environment, wherein the data includes user speech and/or air-gesture commands within one or more user input command areas. The voice and air-gesture capturing system is further configured to identify user input based on analysis of the captured data. More specifically, the voice and air-gesture capturing system is configured to identify specific voice and/or air-gesture commands performed by the user, as well as corresponding user input command areas in which the voice and/or air-gesture commands occurred. The voice and air-gesture capturing system is further configured to identify an application corresponding to the user input based, at least in part, on the identified user input command area and allow the user to interact with and control the identified application based on the user input.

A system consistent with the present disclosure provides a user with an improved means of managing and interacting with a variety of applications by way of assigned user input command areas within a computing environment. For example, in the case of user interaction with a GUI having simultaneous display of multiple windows presented on an electronic display, the system is configured to provide an efficient and effective means of controlling the applications associated with each window. In particular, the system is configured to allow a user to assign three-dimensional command area corresponding to each window presented on the display, such that the user may interact with and control each window and an associated application based on voice and/or air-gesture commands performed within the corresponding three-dimensional command area. Accordingly, a system consistent with the present disclosure allows a user to utilize the same voice and/or air-gesture command to control a variety of different windows by performing such command within one of the assigned user input command areas, thereby lessening the chance for ambiguity and interaction with an unintended window and associated application.

Turning to FIG. 1, one embodiment of a system 10 consistent with the present disclosure is generally illustrated. The system includes a computing device 12, a voice and air-gesture capturing system 14, one or more sensors 16 and an electronic display 18. As described in greater detail herein, the voice and air-gesture capturing system 14 is configured to monitor a computing environment and identify user input and interaction with a graphical user interface (GUI) presented on the electronic display 18 within the computing environment. More specifically, the voice and air-gesture capturing system 14 is configured to allow a user to efficiently and effectively manage multiple open windows of the GUI presented on the electronic display 18, wherein each window corresponds to an open and running application of the computing device 12.

The voice and air-gesture capturing system 14 is configured to allow a user to assign user input command areas for each of the multiple windows, wherein each user input command area defines a three-dimensional space within the computing environment and in relation to at least the electronic display 18 (shown in FIGS. 4 and 5). The voice and air-gesture capturing system 14 is configured to receive data captured by the one or more sensors 16 in the computing environment. The one or more sensors 16 may be configured to capture at least one of user speech and air-gesture commands within one or more assigned user input command areas of the computing environment, described in greater detail herein.

Upon receiving and processing data captured by the one or more sensors 16, the voice and air-gesture capturing system 14 is configured to identify user input based on the captured data. The identified user input may include specific voice and/or air-gesture commands performed by the user, as well as corresponding user input command areas in which the voice and/or air-gesture commands occurred. The voice and air-gesture capturing system 14 is further configured to identify a window corresponding to the user input based, at least in part, on the identified user input command area and allow the user to interact with and control the identified window and associated application based on the user input.

The computing device 12, voice and air-gesture capturing system 14, one or more sensors 16 and electronic display 18 may be configured to communicate with one another via any known wired or wireless communication transmission protocol.

As generally understood, the computing device 12 may include hardware components and/or software components such that the computing device 12 may be used to execute applications, such as gaming applications, non-gaming applications, or the like. In some embodiments described herein, one or more running applications may include associated windows presented on a user interface of the electronic display 18. The computing device 12 may include, but is not limited to, a personal computer (PC) (e.g. desktop or notebook computer), tablet computer, netbook computer, smart phone, portable video game device, video game console, portable digital assistant (PDA), portable media player (PMP), e-book, mobile internet device, personal navigation device, and other computing device.

The electronic display 18 may include any audiovisual display device configured to receive input from the computing device 12 and voice and air-gesture capturing system 14 and provide visual and/or audio information related to the input. For example, the electronic display 18 is configured to provide visuals and/or audio of one or more applications executed on the computing device 12 and based on user input from the voice and air-gesture capturing system 14. The electronic display 18 may include, but is not limited to, a television, a monitor, electronic billboard, high-definition television (HDTV), or the like.

In the illustrated embodiment, the voice and air-gesture capturing system 14, one or more sensors 16 and electronic display 18 are separate from one another. It should be noted that in other embodiments, as generally understood by one skilled in the art, the computing device 12 may optionally include the one or more sensors 16 and/or electronic display 18, as shown in the system 10a of FIG. 2, for example. The optional inclusion of the one or more sensors 16 and/or electronic display 18 as part of the computing device 12, rather than elements external to computing device 12, is denoted in FIG. 2 with broken lines. Additionally, as generally understood, the voice and air-gesture capturing system 14 may be separate from the computing device 12.

Turning to FIG. 3, the system 10 of FIG. 1 is illustrated in greater detail. As previously described, the voice and air-gesture capturing system 14 is configured to receive data captured from at least one sensor 16. As shown, the system 10 may include a variety of sensors configured to capture various attributes of at least one user within a computing environment such as, for example physical characteristics of the user, including movement of one or more parts of the user's body, and audible characteristics, including voice input from the user. For example, in the illustrated embodiment, the system 10 includes at least one camera 20 configured to capture digital images of the computing environment and one or more users within and at least one microphone 22 configured to capture sound data of the environment, including voice data of the one or more users.

FIG. 3 further illustrates the voice and air-gesture capturing system 14 of FIG. 1 in greater detail. It should be appreciated that voice and air-gesture capturing system 14 shown in FIG. 3 is one example of a voice and air-gesture capturing system 14 consistent with the present disclosure. As such, a voice and air-gesture capturing system consistent with the present disclosure may have more or fewer components than shown, may combine two or more components, or a may have a different configuration or arrangement of the components. The various components shown in FIG. 3 may be implemented in hardware, software or a combination of hardware and software, including one or more signal processing and/or application specific integrated circuits.

As shown, the camera 20 and microphone 22 are configure to provide input to a camera and audio framework module 24 of the voice and air-gesture capturing system 14. The camera and audio framework module 24 may include custom, proprietary, known and/or after-developed image processing and/or audio code (or instruction sets) that are generally well-defined and operable to control at least camera 20 and microphone 22. For example, the camera and audio framework module 24 may cause camera 20 and microphone 22 to capture and record images, distances to objects and users within the computing environment and/or sounds, may process images and/or sounds, may cause images and/or sounds to be reproduced, etc. The camera and audio framework module 24 may vary depending on the voice and air-gesture capturing system 14, and more particularly, the operating system (OS) running in the voice and air-gesture capturing system 14 and/or computing device 12.

The voice and air-gesture capturing system 14 further includes a speech and gesture recognition module 26 configured to receive data captured by at least one of the sensors 16 and establish user input 28 based on the captured data. In the illustrated embodiment, the speech and gesture recognition module 26 is configured to receive one or more digital images captured by the at least one camera 20. The camera 20 includes any device (known or later discovered) for capturing digital images representative of a computing environment and one or more users within the computing environment.

For example, the camera 20 may include a still camera (i.e., a camera configured to capture still photographs) or a video camera (i.e., a camera configured to capture a plurality of moving images in a plurality of frames). The camera 20 may be configured to capture images in the visible spectrum or with other portions of the electromagnetic spectrum (e.g., but not limited to, the infrared spectrum, ultraviolet spectrum, etc.). The camera 20 may be further configured to capture digital images with depth information, such as, for example, depth values determined by any technique (known or later discovered) for determining depth values, described in greater detail herein. For example, the camera 20 may include a depth camera that may be configured to capture the depth image of a scene within the computing environment. The camera 20 may also include a three-dimensional (3D) camera and/or a RGB camera configured to capture the depth image of a scene.

The camera 20 may be incorporated within the computing device 12 and/or voice and air-gesture capturing device 14 or may be a separate device configured to communicate with the computing device 12 and voice and air-gesture capturing system 14 via wired or wireless communication. Specific examples of cameras 120 may include wired (e.g., Universal Serial Bus (USB), Ethernet, Firewire, etc.) or wireless (e.g., WiFi, Bluetooth, etc.) web cameras as may be associated with computers, video monitors, etc., mobile device cameras (e.g., cell phone or smart phone cameras integrated in, for example, the previously discussed example computing devices), integrated laptop computer cameras, integrated tablet computer cameras, etc.

In one embodiment, the system 10 may include a single camera 20 within the computing environment positioned in a desired location, such as, for example, adjacent the electronic display 18 (shown in FIG. 5) and configured to capture images of the computing environment and one or more users within the computing environment within close proximity to the electronic display 18. In other embodiments, the system 10 may include multiple cameras 20 positioned in various positions within the computing environment to capture images of one or more users within the environment from different angles so as to obtain visual stereo, for example, to be used in determining depth information.

Upon receiving the image(s) from the camera 20, the speech and gesture recognition module 26 may be configured to identify one or more parts of a user's body within image(s) provided by the camera 20 and track movement of such identified body parts to determine one or more air-gestures performed by the user. For example, the speech and gesture recognition module 26 may include custom, proprietary, known and/or after-developed identification and detection code (or instruction sets), hardware, and/or firmware that are generally well-defined and operable to receive an image (e.g., but not limited to, a RGB color image) and identify, at least to a certain extent, a user's hand in the image and track the detected hand through a series of images to determine an air-gesture based on hand movement. The speech and gesture recognition module 26 may be configured to identify and track movement of a variety of body parts and regions, including, but not limited to, head, torso, arms, hands, legs, feet and the overall position of a user within a scene.

The speech and gesture recognition module 26 may further be configured to identify a specific spatial area within the computing environment in which movement of the user's identified body part occurred. For example, the speech and gesture recognition module 26 may include custom, proprietary, known and/or after-developed spatial recognition code (or instruction sets), hardware, and/or firmware that are generally well-defined and operable to identify, at least to a certain extent, one of a plurality user input command areas in which movement of an identified user body part, such as the user's hand, occurred.

The speech and gesture recognition module 26 is further configured to receive voice data of a user in the computing environment captured by the at least one microphone 22. The microphone 22 includes any device (known or later discovered) for capturing voice data of one or more persons, and may have adequate digital resolution for voice analysis of the one or more persons. It should be noted that the microphone 22 may be incorporated within computing device 12 and/or voice and air-gesture capturing system 14 or may be a separate device configured to communicate with the media voice and air-gesture capturing system 14 via any known wired or wireless communication.

Upon receiving the voice data from the microphone 22, the speech and gesture recognition module 26 may be configured to use any known speech analyzing methodology to identify particular subject matter of the voice data. For example, the speech and gesture recognition module 26 may include custom, proprietary, known and/or after-developed speech recognition and characteristics code (or instruction sets), hardware, and/or firmware that are generally well-defined and operable to receive voice data and translate speech into text data. The speech and gesture recognition module 26 may be configured to identify one or more spoken commands from the user for interaction with one or more windows of the GUI on the electronic display, as generally understood by one skilled in the art.

The speech and gesture recognition module 26 may be further configured to identify a specific spatial area within the computing environment in which user's voice input was projected or occurred within. For example, the speech and gesture recognition module 26 may include custom, proprietary, known and/or after-developed spatial recognition code (or instruction sets), hardware, and/or firmware that are generally well-defined and operable to identify, at least to a certain extent, one of a plurality user input command areas in which a user's voice input was projected towards or within.

In one embodiment, the system 10 may include a single microphone configured to capture voice data within the computing environment. In other embodiments, the system 10 may include an array of microphones positioned throughout the computing environment, each microphone configured to capture voice data of a particular area of the computing environment, thereby enabling spatial recognition. For example, a first microphone may be positioned on one side of the electronic display 18 and configured to capture only voice input directed towards that side of the display 18. Similarly, a second microphone may be positioned on the opposing side of the display 18 and configured to capture only voice input directed towards that opposing side of the display.

Upon receiving and analyzing the captured data, including images and/or voice data, from the sensors 16, the speech and gesture recognition module 26 is configured to generate user input 28 based on the analysis of the captured data. The user input 28 may include, but is not limited to, identified air-gestures based on user movement, corresponding user input command areas in which air-gestures occurred, voice commands and corresponding user input command areas in which voice commands were directed towards or occurred within.

The voice and gesture capturing system 14 further includes an application control module 30 configured to allow a user to interact with each window and associated application presented on the electronic display 18. More specifically, the application control module 30 is configured to receive user input 28 from the speech and recognition module 26 and identify one or more applications to be controlled based on the user input 28.

As shown, the voice and gesture capturing system 14 includes an input mapping module 32 configured to allow a user to assign user input command areas for a corresponding one of a plurality of applications or functions configured to be executed on the computing device 12. For example, the input mapping module 32 may include custom, proprietary, known and/or after-developed training code (or instruction sets), hardware, and/or firmware that are generally well-defined and operable to allow a user to assign a predefined user input command area of the computing environment to a corresponding application from an application database 34, such that any user input (e.g. voice and/or air-gesture commands) within an assigned user input command area will result in control of one or more parameters of the corresponding application.

The application control module 30 may be configured to compare data related to the received user input 28 with data associated one or more assignment profiles 33(1)-33(n) stored in the input mapping module 32 to identify an application associated with the user input 28. In particular, the application control module 30 may be configured to compare the identified user input command areas of the user input 28 with assignment profiles 33(1)-33(n) in order to find a profile that has matching user input command area. Each assignment profile 33 may generally include data related to one of a plurality of user input command areas of the computing environment and the corresponding application to which the one input command area is assigned. For example, a computing environment may include six different user input command areas, wherein each command area may be associated with a separate application. As such, any voice and/or air-gestures performed within a particular user input command area will only control parameters of the application associated with that particular user input command area.

Upon finding a matching profile in the input mapping module 32, by any known or later discovered matching technique, the application control module 30 is configured to identify an application from the application database 34 to which a user input command area in which voice and/or gesture commands occurred is assigned based on the data of the matching profile. The application control module 30 is further configured to permit user control of one or more parameters of the running application based on the user input 28 (e.g. voice and/or air-gesture commands). As generally understood, each application may have a predefined set of known voice and gesture commands from a corresponding voice and gesture database 36 for controlling various parameters of the application.

The voice and air-gesture capturing system 14 further includes a display rendering module 38 configured to receive input from the application control module 30, including user input commands for controlling one or more running applications, and provide audiovisual signals to the electronic display 18 and allow user interaction and control of windows associated with the running applications. The voice and air-gesture capturing system 14 may further include one or more processor(s) 40 configured to perform operations associated with voice and air-gesture capturing system 14 and one or more of the modules included therein.

Turning now to FIGS. 4 and 5, one embodiment of computing environment 100 is generally illustrated. FIG. 4 depicts a front view of one embodiment of an electronic display 18 having an exemplary graphical user interface (GUI) 102 with multiple windows 104(1)-104(n) displayed thereon. As previously described, each window 104 generally corresponds to an application executed on the computing device 102. For example, window 104(1) may correspond to a media player application, window 104(2) may correspond to a video game application, window 104(3) may corresponding to a web browser and window 104(n) may correspond to a word processing application. It should be noted that some applications configured to be executed on the computing device 12 may not include an associated window presented on the display 18. As such, some user input command areas may be assigned to such applications.

As shown, user input command areas A-D are included within the computing environment 100. As previously described, the user input command areas A-D generally define three-dimensional (shown in FIG. 5) spaces in relation to the electronic display 18 and one or more sensor 16 in which the user may perform specific voice and/or air-gesture commands to control one or more applications and corresponding windows 104(1)-104(n).

FIG. 5, a perspective view of the computing environment 100 of FIG. 4 is generally illustrated. As shown, the computing environment 100 includes the electronic display 18 having a GUI 102 with multiple windows 104(1)-104(n) presented thereon. The one or more sensors 16 (in the form of a camera 20 and microphone 22) are positioned within the computing environment 100 to capture user movement and/or speech within the environment 100. The computing environment 100 further includes assigned voice and air-gesture command areas A-E and a user 106 interacting with the multi-window GUI 102 via the command areas A-E. As shown, each user input command area A-E defines a three-dimensional space within the computing environment 100 and in relation to at least the electronic display 18. As previously described, when the user desires to interact with a specific window 104 on the electronic display, the user need only perform one or more voice and/or air-gesture commands within an assigned user input command area A-E associated with the specific window 104.

For example, the user 106 may wish to interact with a media player application of window 104(1) and interact with a web browser of window 104(3). The user may have utilized the voice and air-gesture capturing system 14 to assign user input command area C to correspond to window 104(1) and user input command area E to correspond to window 104(3), as previously described. The user may speak and/or perform one or more motions with one or more portions of their body, such as their arms and hands within the computing environment 100. In particular, the user 106 may speak predefined voice command in a direction towards user input command area C and perform a predefined air-gesture (e.g. wave their arm upwards) within user input command area E.

As previously described, the camera 20 and microphone 22 are configured to capture data related to user's voice and/or air-gesture commands. The voice and air-gesture capturing system 14 is configured to receive and process the captured data to identify user input, including the predefined voice and air-gesture commands performed by the user 106 and the specific user input command areas (areas C and E, respectively) in which the user's voice and air-gesture commands were performed. In turn, the voice and air-gesture capturing system 14 is configured to identify windows 104(1) and 104(3) corresponding to the identified user input command areas (areas C and E, respectively) and further allow the user 106 to control one or more parameters of the applications associated with windows 104(1) and 104(3) (e.g. media player and web browser, respectively) based on the user input.

In the illustrated embodiment, the user input command areas A-E are positioned on all sides of the electronic display 18 (e.g. top, bottom, left and right) as well as the center of the electronic display 18. It should be noted that in other embodiments, the voice and air gesture capturing system 14 may be configured to assign a plurality of different user input command areas in a variety of different dimensions and positions in relation to the electronic display 18 and are not limited to the arrangement depicted in FIGS. 4 and 5.

Turning now to FIG. 6, a flowchart of one embodiment of a method 600 for assigning voice and air-gesture command areas is generally illustrated. The method includes monitoring a computing environment and at least one user within attempting to interact with a user interface (operation 610). The computing environment may include an electronic display upon which the user interface is displayed. The user interface may have a plurality of open windows, wherein each open window may correspond to an open and running application. The method further includes capturing data related to user speech and/or air air-gesture interaction with the user interface (operation 620). The data may be captured by one or more sensors in the computing environment, wherein the data includes user speech and/or air-gesture commands within one or more assigned user input command areas. Each user input command area defines a three-dimensional space within the computing environment and in relation to at least the electronic display.

The method further includes identifying user input and one of a plurality of user input command areas based on analysis of the captured data (operation 630). The user input includes identified voice and/or air-gesture commands performed by the user, as well as corresponding user input command areas in which the identified voice and/or air-gesture commands occurred. The method further includes identifying an associated application presented on the electronic display based, at least in part, on the identified user input command area (operation 640). The method further includes providing user control of the identified associated application based on the user input (operation 650).

While FIG. 6 illustrates method operations according various embodiments, it is to be understood that in any embodiment not all of these operations are necessary. Indeed, it is fully contemplated herein that in other embodiments of the present disclosure, the operations depicted in FIG. 6 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The following examples pertain to further embodiments. In one example there is provided an apparatus for assigning voice and air-gesture command areas. The apparatus may include a recognition module configured to receive data captured by at least one sensor related to a computing environment and at least one user within and identify one or more attributes of the user based on the captured data. The recognition module is further configured to establish user input based on the user attributes, wherein the user input includes at least one of a voice command and air-gesture command and a corresponding one of a plurality of user input command areas in which the voice or air-gesture command occurred. The apparatus may further include an application control module configured to receive and analyze the user input and an application to be controlled by the user input based, at least in part, on the user input command area in which the user input occurred. The application control module is further configured to permit user interaction with and control of one or more parameters of the identified application based on the user input.

The above example apparatus may be further configured, wherein the at least one sensor is a camera configured to capture one or more images of the computing environment and the at least one user within. In this configuration, the example apparatus may be further configured, wherein the recognition module is configured to identify and track movement of one or more user body parts based on the captured images and determine one or more air-gesture commands corresponding to the identified user body part movements and identify a corresponding user input command area in which each air-gesture command occurred.

The above example apparatus may be further configured, alone or in combination with the above further configurations, wherein the at least one sensor is a microphone configured to capture voice data of the user within the computing environment. In this configuration, the example apparatus may be further configured, wherein the recognition module is configured to identify one or more voice commands from the user based on the captured voice data and identify a corresponding user input command area in which each voice command occurred or was directed towards.

The above example apparatus may further include, alone or in combination with the above further configurations, an input mapping module configured to allow a user to assign one of the plurality of user input command areas to a corresponding one of a plurality of applications. In this configuration, the example apparatus may be further configured, wherein the input mapping module includes one or more assignment profiles, each assignment profile includes data related to one of the plurality of user input command areas and a corresponding application to which the one user input command area is assigned. In this configuration, the example apparatus may be further configured, wherein the application control module is configured to compare user input received from the recognition module with each of the assignment profiles to identify an application associated the user input. In this configuration, the example apparatus may be further configured, wherein the application control module is configured to compare identified user input command areas of the user input with user input command areas of each of the assignment profiles and identify a matching assignment profile based on the comparison.

The above example apparatus may be further configured, alone or in combination with the above further configurations, wherein each user input command area includes a three-dimensional space within the computing environment and is positioned relative to an electronic display upon which a multi-window user interface is presented, wherein some of the windows correspond to applications.

In another example there is provided a method for assigning voice and air-gesture command areas. The method may include monitoring a computing environment and at least one user within the computing environment attempting to interact with a user interface, receiving data captured by at least one sensor within the computing environment, identifying one or more attributes of the at least one user in the computing environment based on the captured data and establishing user input based on the user attributes, the user input including at least one of a voice command and an air-gesture command and a corresponding one of a plurality of user input command areas in which the voice or air-gesture command occurred and identifying an application to be controlled by the user input based, at least in part, on the corresponding user input command area.

The above example method may further include permitting user control of one or more parameters of the identified associated application based on the user input.

The above example method may further include, alone or in combination with the above further configurations, assigning one of the plurality of user input command areas to a corresponding one of a plurality of applications and generating an assignment profile having data related to the one of the plurality of user input command areas and the corresponding application to which the user input command area is assigned. In this configuration, the example method may be further configured, wherein the identifying an application to be controlled by the user input includes comparing user input with a plurality of assignment profiles having data related to an application and one of the plurality of user input command areas assigned to the application and identifying an assignment profile having data matching the user input based on the comparison. In this configuration, the example method may be further configured, wherein the identifying a matching assignment profile includes comparing identified user input command areas of the user input with user input command areas of each of the assignment profiles and identifying an assignment profile having a matching user input command area.

In another example, there is provided at least one computer accessible medium storing instructions which, when executed by a machine, cause the machine to perform the operations of any of the above example methods.

In another example, there is provided a system arranged to perform any of the above example methods.

In another example, there is provided a system for assigning voice and air-gesture command areas. The system may include means for monitoring a computing environment and at least one user within the computing environment attempting to interact with a user interface, means for receiving data captured by at least one sensor within the computing environment, means for identifying one or more attributes of the at least one user in the computing environment based on the captured data and establishing user input based on the user attributes, the user input including at least one of a voice command and an air-gesture command and a corresponding one of a plurality of user input command areas in which the voice or air-gesture command occurred and means for identifying an application to be controlled by the user input based, at least in part, on the corresponding user input command area.

The above example system may further include means for permitting user control of one or more parameters of the identified associated application based on the user input.

The above example system may further include, alone or in combination with the above further configurations, means for assigning one of the plurality of user input command areas to a corresponding one of a plurality of applications and means for generating an assignment profile having data related to the one of the plurality of user input command areas and the corresponding application to which the user input command area is assigned. In this configuration, the example system may be further configured, wherein the identifying an application to be controlled by the user input includes means for comparing user input with a plurality of assignment profiles having data related to an application and one of the plurality of user input command areas assigned to the application and means for identifying an assignment profile having data matching the user input based on the comparison. In this configuration, the example system may be further configured, wherein the identifying a matching assignment profile includes means for comparing identified user input command areas of the user input with user input command areas of each of the assignment profiles and identifying an assignment profile having a matching user input command area.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. An apparatus for assigning voice and air-gesture command areas, said apparatus comprising:
a recognition module configured to receive data captured by at least one sensor related to a computing environment and at least one user within and identify one or more attributes of said user based on said captured data and establish user input based on said user attributes, wherein said user input includes at least one of a voice command and air-gesture command and a corresponding one of a plurality of user input command areas in which said voice or air-gesture command occurred; and
an application control module configured to receive and analyze said user input and an application to be controlled by said user input based, at least in part, on said user input command area in which said user input occurred and permit user interaction with and control of one or more parameters of said identified application based on said user input.

2. The apparatus of claim 1, wherein said at least one sensor is a camera configured to capture one or more images of said computing environment and said at least one user.

3. The apparatus of claim 2, wherein said recognition module is configured to identify and track movement of one or more user body parts based on said captured images and determine one or more air-gesture commands corresponding to said identified user body part movements and identify a corresponding user input command area in which each air-gesture command occurred.

4. The apparatus of claim 1, wherein said at least one sensor is a microphone configured to capture voice data of said user within said computing environment.

5. The apparatus of claim 4, wherein said recognition module is configured to identify one or more voice commands from said user based on said captured voice data and identify a corresponding user input command area in which each voice command occurred or was directed towards.

6. The apparatus of claim 1, further comprising an input mapping module configured to allow a user to assign one of said plurality of user input command areas to a corresponding one of a plurality of applications.

7. The apparatus of claim 6, wherein said input mapping module comprises one or more assignment profiles, each assignment profile comprising data related to one of said plurality of user input command areas and a corresponding application to which said one user input command area is assigned.

8. The apparatus of claim 7, wherein said application control module is configured to compare user input received from said recognition module with each of said assignment profiles to identify an application associated said user input.

9. The apparatus of claim 8, wherein said application control module is configured to compare identified user input command areas of said user input with user input command areas of each of said assignment profiles and identify a matching assignment profile based on said comparison.

10. The apparatus of claim 1, wherein each user input command area comprises a three-dimensional space within said computing environment and is positioned relative to an electronic display upon which a multi-window user interface is presented, wherein some of said windows correspond to associated applications.

11. At least one computer accessible medium storing instructions which, when executed by a machine, cause the machine to perform operations for assigning voice and air-gesture command areas, said operations comprising:
monitoring a computing environment and at least one user within said computing environment attempting to interact with a user interface;
receiving data captured by at least one sensor within said computing environment;
identifying one or more attributes of said at least one user in said computing environment based on said captured data and establishing user input based on said user attributes, said user input including at least one of a voice command and an air-gesture command and a corresponding one of a plurality of user input command areas in which said voice or air-gesture command occurred; and
identifying an application to be controlled by said user input based, at least in part, on said corresponding user input command area.

12. The computer accessible medium of claim 11, further comprising permitting user control of one or more parameters of said identified associated application based on said user input.

13. The computer accessible medium of claim 11, further comprising:
assigning one of said plurality of user input command areas to a corresponding one of a plurality of applications; and
generating an assignment profile having data related to said one of said plurality of user input command areas and said corresponding application to which said user input command area is assigned.

14. The computer accessible medium of claim 13, wherein said identifying an application to be controlled by said user input comprises:
comparing user input with a plurality of assignment profiles having data related to an application and one of said plurality of user input command areas assigned to said application; and
identifying an assignment profile having data matching said user input based on said comparison.

15. The computer accessible medium of claim 14, wherein said identifying a matching assignment profile comprises:
comparing identified user input command areas of said user input with user input command areas of each of said assignment profiles and identifying an assignment profile having a matching user input command area.

16. A method for assigning voice and air-gesture command areas, said method comprising:
monitoring a computing environment and at least one user within said computing environment attempting to interact with a user interface;
receiving data captured by at least one sensor within said computing environment;
identifying one or more attributes of said at least one user in said computing environment based on said captured data and establishing user input based on said user attributes, said user input including at least one of a voice command and an air-gesture command and a corresponding one of a plurality of user input command areas in which said voice or air-gesture command occurred; and
identifying an application to be controlled by said user input based, at least in part, on said corresponding user input command area.

17. The method of claim 16, further comprising permitting user control of one or more parameters of said identified associated application based on said user input.

18. The method of claim 16, further comprising:
assigning one of said plurality of user input command areas to a corresponding one of a plurality of applications; and
generating an assignment profile having data related to said one of said plurality of user input command areas and said corresponding application to which said user input command area is assigned.

19. The method of claim 18, wherein said identifying an application to be controlled by said user input comprises:
comparing user input with a plurality of assignment profiles having data related to an application and one of said plurality of user input command areas assigned to said application; and
identifying an assignment profile having data matching said user input based on said comparison.

20. The method of claim 19, wherein said identifying a matching assignment profile comprises:
comparing identified user input command areas of said user input with user input command areas of each of said assignment profiles and identifying an assignment profile having a matching user input command area.
